(19) United States
(12) Patent Application Publication
(10) Pub. No.: US 2004/0164544 A1
(43) Pub. Date: Aug. 26, 2004

(54) Laser wristband sheet with embedded closure mechanism

(76) Inventors: Irwin Thall, Thousand Oaks, CA (US); Oswaldo Penuela, Saugus, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/785,243

(22) Filed: Feb. 23, 2004

Related U.S. Application Data
(63) Continuation-in-part of application No. 10/322,320, filed on Dec. 17, 2002.

(51) Int. Cl. B42D 15/00; G09C 3/00

(52) U.S. Cl. 283/62

(57) ABSTRACT

A laser band sheet or form with detachable labels is provided. The sheet includes a strip or wristband having a plurality of sizing holes and a closure “snap” mechanism or fastener that is integral to the sheet. The fastener can be constructed of a tear-resistant material that is different than the material used for other portions of the sheet. The fastener can provide a stronger closure for the strip than many adhesive-based closure designs. Because the fastener is integral with the sheet, there may be no need for a container of separately-provided fasteners.

### CROSS REFERENCE TO RELATED APPLICATIONS

This is a continuation-in-part application that claims priority from U.S. application Ser. No. 10/322,320, filed Dec. 17, 2002.

### 1. FIELD OF THE INVENTION

This invention relates to a printable form. More particularly, the present invention relates to a multi-part form having a detachable strip or wristband accompanied by a plurality of detachable labels, cards, tags, etc. which may be printed with information in a single pass through a printer.

### 2. BACKGROUND

The use of identification wristbands in hospital settings to identify individual patients is a common practice. The identification wristband, which may include the patient's name and room number, is generally secured around the wrist of the patient during his or her stay at the hospital. While this has been useful to identify patients, some hospitals and medical clinics have experienced problems correlating patients with information relating to their lab results, specimens, prescriptions, billing, newborn babies, etc. Clerical errors in the handling of such routine matters can result in the dispensing of the wrong medicine or a newborn baby going home with the wrong mother.

Attempts have been made to improve the correlation of patient information to lab results, specimens, prescriptions, etc. For example, Falla, U.S. Pat. No. 4,122,947, teaches a pre-packaged patient identification kit that includes a wristband, a specimen container, and a label for attachment to a patient's record, all of which have been provided with identical patient information. However, more than one specimen container or label may be required and adding pre-identified specimen containers to the identification kit can increase the cost of such a kit. In another example, Huddleston et al., U.S. Pat. No. 5,653,472, teaches a form having a detachable wristband and labels. While kits and forms such as those described above may provide means of identifying a patient for various purposes, such items either lack more than two different types of identification elements and/or limit the end users' flexibility in using multi-part printable forms to create various patient indicia on one or more materials.

Moreover, many wristbands use either an adhesive closure that is peeled away with the wristband when it is detached from the label sheet, or a separate, plastic snap closure that is provided separately from the label sheet. The adhesive closures sometimes do not provide the closing strength desired. The plastic snaps may have a greater closing strength, but often are provided as a component that is separate from the label sheet and thus can have an associated increased manufacturing cost.

Accordingly, there is a need for a low-cost identification media that includes a wristband (or other band or strip) having improved closing strength. Further there is a need for an identification media that can provide multiple identification elements containing identical and/or overlapping information and that is capable of being produced in any desired quantity or as the needs arises. The present invention fulfills these needs and provides other related advantages.

### SUMMARY OF THE ILLUSTRATED EMBODIMENTS

There is disclosed a laser band sheet or form with detachable labels. The sheet further includes a strip or wristband having a plurality of sizing holes and a closure “snap” mechanism or fastener that is integral to the sheet (i.e. the snap is die cut into the sheet). The snap mechanism can be constructed of a tear-resistant material that is different than the material used for other portions of the sheet. The snap mechanism can provide a stronger closure for the strip than many adhesive-based closure designs. Because the snap is integral with the sheet, there is no need for a container of separately-provided fasteners.

In one embodiment, a band blank or form is for use with a printer adapted to output a printed image. The blank includes a face sheet having a first face sheet surface and a second face sheet surface wherein one of the first or second surfaces is adapted to receive the printed image. The face sheet includes a fastener and a strip or wristband having a first end, a second end, and a strip coupler. The strip and the fastener can be separated from the face sheet and from each other. The fastener engages the strip coupler so that the first and second ends of the strip are attached to one another.

In one aspect, the band blank further includes a liner sheet underlying the face sheet and having first and second liner surfaces. A release coating is on at least a portion of one of the first or second liner surfaces and releasably adheres the liner sheet to the face sheet. The strip and the fastener can be separated from the liner sheet when they are separated from the face sheet.

In another aspect, the fastener has a generally elongated shape with a proximate end and a distal end. The proximate end terminates in a generally triangle-shaped portion having a point and two wings that can be folded toward one another. The distal end has a fastener opening. The fastener opening is sized to permit the triangle-shape portion to pass through the opening when the two wings are folded toward one another and to inhibit the triangle-shape portion from passing through the opening when the two wings are unfolded.

In another aspect, the strip coupler is comprised of a first strip opening formed at the first end of the strip and a second strip opening formed at the second end of the strip. Each of the first and second strip openings is adapted to permit at least a portion of the fastener to pass through.

In yet another aspect, the band blank further includes a radio frequency identification (RFID) tag embedded in the face sheet.

In an alternative embodiment, the band blank includes a face ply having first and second face ply surfaces wherein one of the surfaces is adapted to receive a printed image. The face ply further includes first and second die cut patterns. The first die cut pattern has the shape of a fastener, and the second die cut pattern has the shape of a strip having a first end, a second end and a first strip opening. A liner ply underlies the face ply and has first and second liner surfaces. A release coating is disposed on at least a portion of one of the first or second liner surfaces and releasably adheres the liner ply to the face ply. The strip and fastener can be separated from the liner ply, the face ply and from each other. The fastener engages the first strip opening so that the first and second ends of the strip are attached to one another.

In yet another alternative embodiment, a form comprises a face ply having first and second face ply surfaces wherein one of the surfaces is adapted to receive a printed image. The face ply includes a first face ply portion comprising a fastener and a strip. The strip has a first end, a second end, and a first strip opening. The face ply further includes a second face ply portion comprised of a plurality of labels. A pressure sensitive adhesive is on at least a part of one of the first or second face ply surfaces. A liner ply underlies the face ply and has first and second liner surfaces. A release coating is on at least a part of one of the first or second liner surfaces and is adapted to releasably adhere the liner ply to the pressure sensitive adhesive on the face ply. Each of the plurality of labels can be separated from the face ply, the liner ply and from each other. Additionally, the strip and the fastener can be separated from the face ply, the liner ply and from each other. The fastener engages the first strip opening so that the first and second ends of the strip can be attached to one another.

In one aspect, the face ply further includes a third face ply portion, wherein the first, second and third face ply portions are separable from one another.

In another aspect, the first face ply portion is constructed of polymer and is die cut to form the fastener and the strip. The second face ply portion is constructed of paper and is die cut to form the plurality of labels. The face ply further includes a third face ply portion having a plurality of removable cards formed by a die cut.

There are additional aspects to the present inventions. It should therefore be understood that the preceding is merely a brief summary of some of their embodiments and aspects. Additional embodiments and aspects of the present inventions are referenced below. It should further be understood that numerous changes to the disclosed embodiments may be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

FIG. 1 is a top plan view of a multi-part form according to one embodiment of the invention.

FIG. 2 is a cross-sectional view of the multi-part form taken along line 2-2 in FIG. 1.

FIG. 3 is an enlarged, fragmented view of the area indicated by the line 3 in FIG. 2.

FIG. 4 is an enlarged, fragmented view of the area indicated by the line 4 in FIG. 2.

FIG. 5 is a top plan view of the form similar to FIG. 1, showing the strip and fastener detached from the form and exposing the liner ply, showing some labels partially detached from the form and exposing the liner ply, and showing one card partially detached from the form.

FIG. 6 is an enlarged top plan view of the fastener of FIG. 1.

FIG. 7 is a sectional view taken along line 6-6 of FIG. 2, illustrating a release coating applied to a liner ply.

FIG. 8 is a sectional view, taken along line 7-7 of FIG. 2, illustrating an adhesive coating applied to a face ply.

FIGS. 9a and 9b are perspective views each illustrating the strip secured by a fastener.

FIG. 10 is a perspective view of a stack of continuous forms constructed in accordance with one embodiment of the present invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

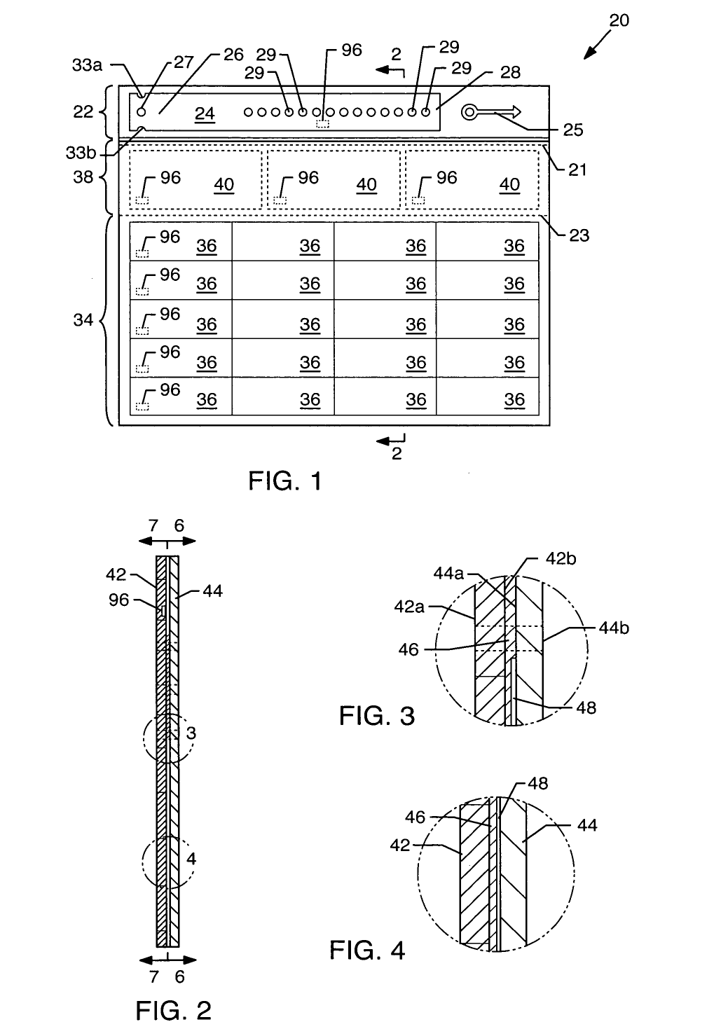

Referring to FIGS. 1-4, there is shown a multi-part form 20 or blank for use with a printer that can output a printed image. The form 20 has a face ply 42 having first and second face ply surfaces 42a, 42b. The first face ply surface 42a is adapted to receive printed images produced by the printer. Such images may include text, pictures, logos, bar codes, etc. The face ply 42 has first, second and third (or intermediate) face ply portions 22, 34, 38 that are separable from one another as the result of die cuts 21, 23 formed between the portions. Each of the portions 22, 34, 38 of the face ply 42 may be constructed of a different material, or the entire face ply 42 may be constructed of the same material. For example, the first portion 22 of the face ply may be comprised of a different material than the intermediate portion 38 of the face ply while the second portion 34 of the face ply may be the same material as that of the intermediate portion 38. Various materials may be used, including but not limited to paper, paper-like materials, polyester, polymer, etc.

The first ply portion 22 is die cut to form a detachable fastener 25 and a detachable strip 24. The strip 24 has a first end 26, a second end 28, a first strip opening 27 formed at the first end 26 of the strip 24, and a plurality of additional strip openings 29 formed at the second end 28 of the strip. Where the strip 24 is used as a wristband, it may be desirable to use a durable material for the first portion 22 of the face ply such that the wristband is strong enough to be worn for several hours, if not days. The strip 24 further has a pair of notches 33a, 33b disposed adjacent to the first strip opening to facilitate connection with the fastener 25 as explained further below.

The second face ply portion 34 is constructed of paper and is die cut to form a plurality of detachable labels 36. The third face ply portion 38 has a plurality of removable cards 40 formed by a die cut, such as a punch-out card that separates from the form along die-cut perforations. The cards 40 can be used as business cards, identification cards, tags, etc. If the card 40 is used as a tag, a perforation in the form of a circle can be die-cut in the card in order to form a hole (not shown) that can be used, for example, to attach the tag to a patient's body part. The labels 36 and cards 40 are rectangular in shape, but alternative embodiments may include a circular, triangular, or any other shape.

The strip 24, the labels 36, and the cards 40 may be printed with indicia that is identical in each portion 22, 34, 38 (i.e., indicia printed on the first portion 22 corresponds to the indicia printed on the second portion 34 and/or the indicia printed on the intermediate portion 38). This identical information may include “nonvariable” information (i.e., information which does not change from label to label or patient to patient) such as the name of the hospital or the hospital department (e.g., maternity, oncology, etc.). The identical information may also include “variable” information (i.e., information which is unique to an individual and which changes from patient to patient) such as the individual's name, blood-type, patient number assigned by the hospital (in numeric or bar code form), etc.

Alternatively, the strip 24, the labels 36, and the cards 40 may be printed with indicia that differs from portion-to-portion. For example, the first, second and intermediate portions 22, 34, 38 may each be printed with a different set or subset of patient information but with at least one common item of identifying patient information. In this example, the strip 24 may contain the patient's name, blood-type and patient identification number in bar code form while the detachable labels 36 or cards 40 may only contain the bar code corresponding to the patient identification number.

Hospital personnel would be able to access all of the patient's information by scanning the bar code with a bar code reader attached to a stand-alone computer in which patient records are stored, or a workstation, wireless device, cellular phone or other similar device in communication with the hospital's mainframe computer in which the patient's information is stored. In another alternative, the strip 24, the labels 36, and the cards 40 may be printed with completely different patient identification information (e.g., the strip 24 includes the patient's name only, the labels 36 include only the patient's identification number in barcode form, and the cards 40 include only the patient's identification number in numeric form). The patient identification information printed on the strip 24, the labels 36, and the cards 40 may be adjusted to meet the individual needs of a particular patient.

Referring to FIGS. 2-8, a liner ply 44 underlies the face ply 42 and has first and second liner surfaces 44a, 44b. The liner ply 44 further has first, second and third liner ply portions 22a, 34a, 38a. A pressure sensitive adhesive 46 is disposed on a portion of the second face ply surface 42b. A release coating 48 is disposed on a portion of the first liner surface 44a which faces the second surface 42b of the face ply 42. The release coating 48 permits the liner ply 44 to releasably adhere to the pressure sensitive adhesive 46 on the face ply 42 so that the face ply 42 may be readily peeled away from the liner ply 44. The face and liner plies 42, 44 are oriented with respect to one another so that the first, second and third liner ply portions 22a, 34a, 38a adhere to the first, second and third face ply portions 22, 34, 38, respectively. The release coating 48 may be in the form of a silicone coating. However as seen in FIGS. 3 and 7, the section of the liner ply 44 corresponding to the intermediate portion 38a is not covered with the release coating. The die-cut perforations forming the cards in the intermediate portion extend through both the face ply 42 and the liner ply 44.

The form 20 may be configured as a single sheet that may be printed in a single pass through a printer to provide the elements of the form with correlating printed indicia, including but not limited to bar codes. The face ply 42 may be printed using a number of different automated printing devices including impact printers, ion deposition printers, ink jet printers, laser printers, direct thermal printers, and thermal transfer printers. If direct thermal printing is used, an imaging coating must be provided on the face ply 42 of the form 20. In the alternative, the form 20 may be printed as one sheet of a plurality of co-planar sheets being printed concurrently.

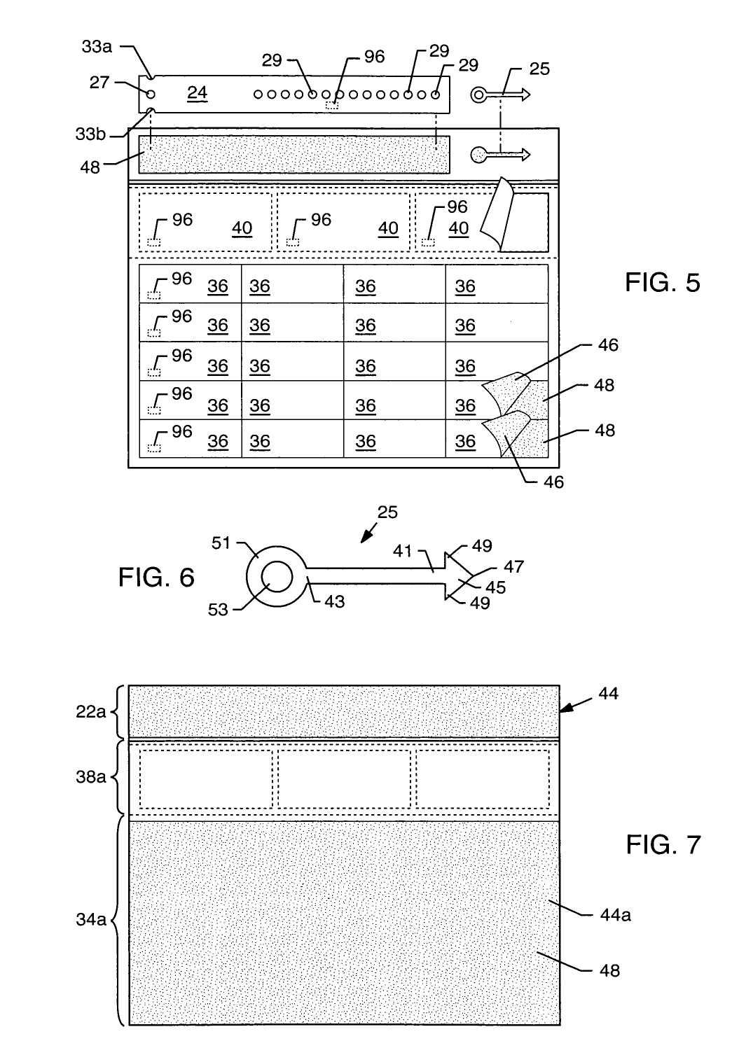

The strip 24 and fastener 25 are detachable from the form 20, and FIG. 5 also shows two of the labels 36 partially peeled away from a section of the liner ply 44. One of the cards 40 is also shown partially detached from the form 20. A detached card 40 includes a portion of both the face ply 42 and the liner ply 44, and thus openings are formed in the remaining portions of the face ply 42 and the liner ply 44 when the card 40 is removed. In this embodiment, there are five rows and four columns of the detachable labels 36. The sizes of the cards 40 in the intermediate portion may vary. For example, in this embodiment of the invention, there are three rectangular cards of equal size.

FIGS. 3 and 7 show that portions of the first surface 44a of the liner ply 44 include the release coating 48. For example, the release coating 48 is included in first portion 22a and in the second portion 34a to allow the release of the strip 24, the fastener 25 and the detachable labels 36. The release coating 48 may be full coated or pattern coated, as seen in FIG. 7, if there are areas, such as the cards 40 in the intermediate portion 38a, where the release coating 48 may not be necessary.

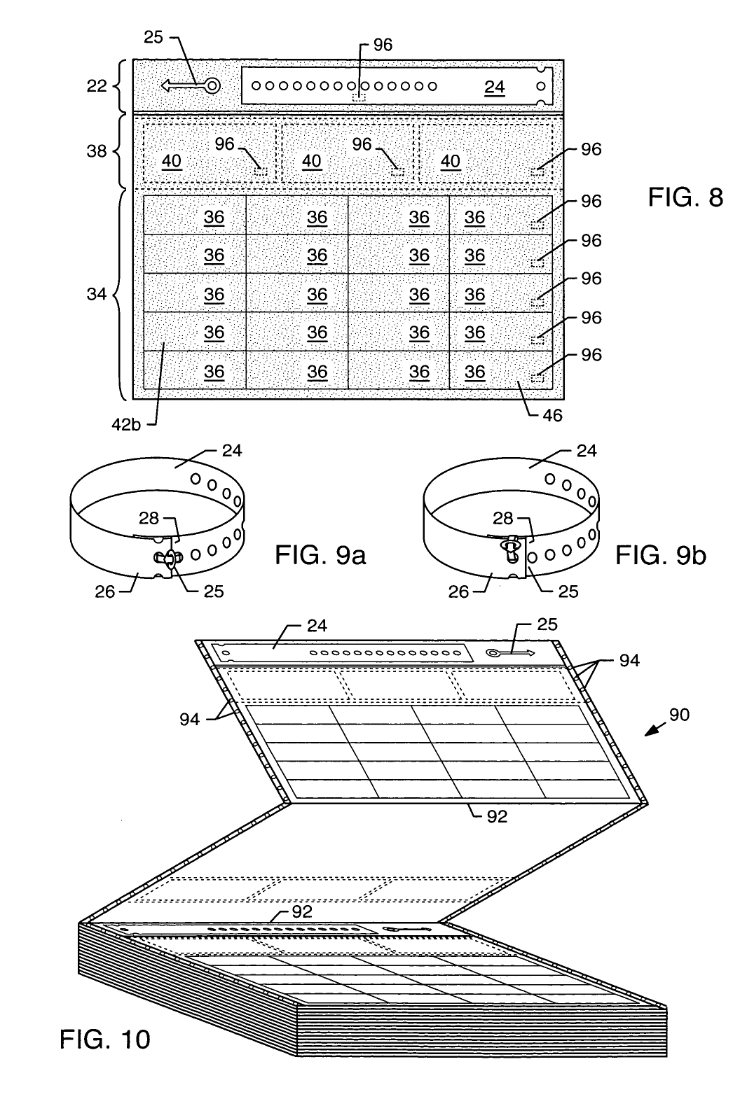

As represented by the dotted areas of FIG. 8, portions of the second surface 42b of the face ply 42 include the pressure sensitive adhesive 46. The pressure sensitive adhesive 46 is included in the first portion 22 around and outside the periphery of the strip 24 and the fastener 25. In the second portion 34, the pressure sensitive adhesive 46 is included in the area containing the detachable labels 36. The pressure sensitive adhesive 46 may be pattern-coated or full coated, as shown in FIG. 8 where, in the intermediate portion 38, the pressure sensitive adhesive 46 is included in the area containing the cards 40.

Each of the plurality of labels 36 may be separated from the face ply 42, the liner ply 44 and from each other. Similarly, the strip 24 and the fastener 25 each may be separated from the face ply 42, the liner ply 44 and from each other. As best seen in FIGS. 6, 9a and 9b, the fastener 25 has a generally elongated shape with a proximate end 41 and a distal end 43. The proximate end 41 terminates in a generally triangle-shaped portion 45 having a point 47 and two wings 49 that are adapted to be folded toward one another. The distal end 43 terminates in a generally circular shaped portion 51 having a fastener opening 53. The size of the fastener opening 53 permits the triangle shape portion 45 to pass through the opening 53 when the two wings 49 are folded toward one another, yet inhibits the triangle shape portion 45 from passing through the opening 53 when the two wings 49 are unfolded, thus permitting the fastener 25 to lock into a closed position.

The fastener 25 can engage the first strip opening 27 and at least one of the plurality of additional strip openings 29, whereby each of said first strip opening 27 and at least one of the plurality of additional strip openings 29 permits the fastener 25 to pass through so that the first end 26 of the strip is attached to the second end 28 of the strip. The strip 24 thus forms a connected loop that can be used as a wristband or as any other loop-shaped device where it is desirable to attach the strip 24 to a person's body or to some other object. The diameter or size of the loop can be made to vary by the selection of one or more of the plurality of additional strip openings 29 through which to insert the fastener 25.

FIGS. 9a and 9b illustrate that, after the strip 24 and fastener 25 are peeled away from the liner ply 44, the strip 24 can be wrapped around a user's wrist (not shown for clarity) where the first end 26 is wrapped around the strip in an overlapping position so that the first end 26 overlaps the second end 28. The first end 26 is secured to the second end 28 by the fastener 25 that is passed through the first strip opening 27 as well as through one or more of the plurality of additional strip openings 29, the selection of which is dictated by the desired size of the loop that is to be formed. The fastener 25 can wrap around the end portion of the first end 26 of the strip 24 as shown in FIG. 9a. Alternatively, the fastener 25 can wrap around the elongated edge portion of the first end 26 of the strip 24 as shown in FIG. 9b. In this position, the fastener 25 can be positioned within one of the notches 33a, 33b for a more secure fit of the fastener 25.

The fastener 25 is locked into position by folding the fastener wings 49 inward toward one another and passing the point 47 of the proximate end 41 of the fastener through the fastener opening 53 at the fastener distal end 43 thereby forming a small fastener loop. The fastener wings 49 are then unfolded thereby inhibiting the passage of the triangle shaped portion 45 of the fastener 25 back through the fastener opening 53 thus locking the fastener 25 in position.

While the illustrated embodiment shows a strip coupler in the form of a plurality of holes or openings in the strip 24 that are adapted to engage with the fastener 25, it will be appreciated by those skilled in the art that other types of couplers having different geometries and features may be employed. Moreover, while the illustrated fastener 25 shows the triangle-shaped portion 45 that interlocks with the fastener opening 53, alternative embodiments may include any other geometric arrangement whereby one end of a fastener interlocks with the other end thereby forming a fastener loop. In yet further alternative embodiments, the fastener need not have interlocking ends at all, but rather can comprise one or more relatively straight members that do not form a fastener loop in order to connect the two ends of a strip or wristband. Rather, these fasteners can include elements of various geometric shapes that can be folded for insertion through one or more openings in a strip and that can be unfolded for engagement with the strip while the fasteners themselves remain relatively straight.

As illustrated in FIG. 10, the present invention may be produced as a continuous series of forms 90 detachably connected end-to-end along die-cut perforations (i.e., lines of weakness) 92 located between the forms at the top and/or bottom of each form. The series of forms 90 may be stackable in a zigzag fashion. This continuous series of forms may be fed through a printer in a single pass to add the indicia simultaneously on the strip 24 as well as the cards 40 and labels 36. The continuous series of forms 90 include standard vertical perforations (i.e., tractor feed pin holes) 94 on both sides of each form for use with printers that include pin-feed protrusions. However, alternative embodiments of the invention may include forms that are not detachably connected to one another.

Referring again to FIG. 1, a plurality of RFID tags 96 or inlets (i.e. chips and antennas that are adapted to wirelessly transmit or receive information) may be embedded in the strip 24, labels 36, cards 40 or other elements to afford a higher degree of identification capability. A reader (not shown) is used to “read” the chip. Any commercially available RFID tag may be used, including, for example, RFID tags manufactured by Texas Instruments Incorporated, Royal Philips Electronics (i.e., Koninklijke Philips Electronics N.V.) and Infineon Technologies AG.

In one use, a patient will check into a hospital and provide the hospital with standard information, such as the patient's name, health insurance provider, blood type, age, etc. This information will be used to create a hospital chart for the patient as well as a computerized record of the information. The hospital may then use a multi-part form to create a strip or wristband, labels and cards that will be attached to and/or accompany the patient and/or the patient's chart or specimens. The wristband, labels, and cards may be printed with the name of the hospital and the hospital department that the patient is checked into.

For example, a woman about to give birth will usually be checked into a hospital's maternity ward. The patient will then be provided a wristband that may include her name, blood type, and patient identification number, in addition to the information described above. A label may be adhered to the hospital chart prepared by the hospital staff. The label may include the patient's identification number in numeric or barcode form so that a doctor or nurse at the patient's bedside or nurse's station can scan the barcode and pull up the patient's records from the hospital's computer database.

While waiting to give birth, blood samples may be taken from the patient and analyzed. Labels with the patient's identification number (in numeric and/or barcode form) may be attached to the samples so that lab technicians will be able to identify from which patient the sample was taken and/or call up the patient's records so that additional entries can be made by the lab technician with respect to the test results on the sample. Once the patient has given birth, a label or card with the mother's information may be attached to a wristband provided to the infant and/or attached to the infant's chart. The infant may also be provided with his or her own identification number. The mother's and infant's information may then be coordinated so that babies are not accidentally switched by the hospital.

While the form 20 of the present invention has been described in a hospital or medical setting, applications are possible in other settings. The present invention is also applicable in business, recreational, or security settings where identification security is combined with the need to match two or more elements. One example includes the matching of an airline passenger with his/her luggage where the baggage identification label issued to the passenger is compared to the baggage identification label attached to the luggage.

Thus there is disclosed a laser band sheet or form with detachable labels. The sheet includes a strip or wristband having a plurality of sizing holes and a closure “snap” mechanism or fastener that is integral to the sheet. The snap mechanism can be constructed of a tear-resistant material that is different than the material used for other portions of the sheet. The snap mechanism can provide a stronger closure for the strip than many adhesive-based closure designs. Because the snap is integral with the sheet, there may be no need for a container of separately-provided fasteners.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A band blank for use with a printer adapted to output a printed image, comprising:
a face sheet having a first face sheet surface and a second face sheet surface wherein one of the first and second face sheet surfaces is adapted to receive the printed image, the face sheet comprising:
a fastener; and
a strip having a first end, a second end, and a strip coupler;
wherein the strip and the fastener are adapted to be separated from the face sheet and from each other; and
wherein the fastener is adapted to engage the strip coupler so that the first end of the strip is attached to the second end of the strip when the strip and the fastener are separated from the face sheet.

2. The band blank of claim 1 further comprising:
a liner sheet underlying the face sheet and having a first liner surface and a second liner surface; and
a release coating on at least a portion of one of the first and second liner surfaces and adapted to releasably adhere the liner sheet to the face sheet;
wherein the strip and the fastener are further adapted to be separated from the liner sheet when the strip and the fastener are separated from the face sheet.

3. The band blank of claim 1 wherein the fastener has a generally elongated shape with a proximate end and a distal end, the proximate end terminating in a generally triangle-shaped portion having a point and having two wings adapted to be folded toward one another, the distal end having a fastener opening adapted to permit the triangle-shaped portion to pass through the fastener opening when the two wings are folded toward one another and to inhibit the triangle-shaped portion from passing through the fastener opening when the two wings are unfolded.

4. The band blank of claim 3 wherein the strip coupler is comprised of a first strip opening formed at the first end of the strip and a second strip opening formed at the second end of the strip, wherein each of said first and second strip openings is adapted to permit at least a portion of the fastener to pass through.

5. The band blank of claim 4 wherein the strip coupler defines a notch disposed adjacent to the first strip opening.

6. The band blank of claim 1 wherein the strip coupler is comprised of a plurality of strip openings formed by the strip, each of said strip openings being adapted to permit at least a portion of the fastener to pass through.

7. The band blank of claim 1 in which the blank comprises a continuous web of blanks.

8. The band blank of claim 7 wherein the continuous web of blanks includes a plurality of tractor feed pin holes.

9. The band blank of claim 1 wherein at least a portion of the face sheet is constructed of a polymer.

10. The band blank of claim 1 wherein the face sheet is die cut to form the fastener and the strip.

11. The band blank of claim 1 wherein the strip is a wristband.

12. The band blank of claim 1 further comprising a radio frequency identification (RFID) tag embedded in the face sheet.

13. A band blank for use with a printer adapted to output a printed image, comprising:
a face ply having a first face ply surface and a second face ply surface wherein one of the first and second face ply surfaces is adapted to receive the printed image, the face ply comprising:
a first die cut pattern disposed in the face ply and having the shape of a fastener;
a second die cut pattern disposed in the face ply and having the shape of a strip having a first end, a second end and a first strip opening;
a liner ply underlying the face ply and having a first liner surface and a second liner surface; and
a release coating on at least a portion of one of the first and second liner surfaces and adapted to releasably adhere the liner ply to the face ply;
wherein the strip and the fastener are adapted to be separated from the liner ply, the face ply and from each other; and
wherein the fastener is adapted to engage the first strip opening so that the first end of the strip is attached to the second end of the strip when the strip and the fastener are separated from the liner ply and the face ply.

14. The band blank of claim 13 wherein the fastener has a generally elongated shape with a proximate end and a distal end, the proximate end terminating in a generally triangle-shaped portion having a point and having two wings adapted to be folded toward one another, the distal end having a fastener opening adapted to permit the triangle-shaped portion to pass through the fastener opening when the two wings are folded toward one another and to inhibit the triangle-shaped portion from passing through the fastener opening when the two wings are unfolded.

15. The band blank of claim 14 wherein the strip further has a second strip opening, wherein the first strip opening is formed at the first end of the strip and the second strip opening is formed at the second end of the strip, wherein each of said first and second strip openings is adapted to permit at least a portion of the fastener to pass through.

16. The band blank of claim 15 wherein the strip defines a notch disposed adjacent to the first strip opening.

17. The band blank of claim 13 wherein the strip further has a plurality of additional strip openings, wherein the first strip opening and each of said plurality of additional strip openings is adapted to permit at least a portion of the fastener to pass through.

18. The band blank of claim 13 wherein the strip is a wristband.

19. The band blank of claim 13 further comprising a radio frequency identification (RFID) tag embedded in the strip.

20. The band blank of claim 13 wherein the face ply further comprises a third die cut pattern disposed in the face ply and having the shape of a label, wherein the label is adapted to be separated from the liner ply and the face ply, the band blank further comprising:
a radio frequency identification (RFID) tag embedded in the label.

21. The band blank of claim 13 wherein the face ply and the liner ply have a third die cut pattern disposed in the face ply and the liner ply, said third die cut pattern having the shape of a card, wherein the card is adapted to be removed from the liner ply and the face ply thereby forming a first opening in the face ply and a second opening in the liner ply, the band blank further comprising:
a radio frequency identification (RFID) tag embedded in the card.

22. A multi-part form for use with a printer adapted to output a printed image, comprising:
a face ply having a first face ply surface and a second face ply surface wherein one of the first and second face ply surfaces is adapted to receive the printed image, the face ply comprising:
a first face ply portion comprising a fastener and a strip, said strip having a first end, a second end, and a first strip opening; and
a second face ply portion comprising a plurality of labels;
a pressure sensitive adhesive on at least a part of one of the first and second face ply surfaces;
a liner ply underlying the face ply and having a first liner surface and a second liner surface; and
a release coating on at least a part of one of the first and second liner surfaces and adapted to releasably adhere the liner ply to the pressure sensitive adhesive on the face ply;
wherein each of the plurality of labels is adapted to be separated from the face ply, the liner ply and from each other;
wherein the strip and the fastener are adapted to be separated from the face ply, the liner ply and from each other; and
wherein the fastener is adapted to engage the first strip opening so that the first end of the strip is attached to the second end of the strip when the strip and the fastener are separated from the face ply and the liner ply.

23. The multi-part form of claim 22 wherein the strip is a wristband.

24. The multi-part form of claim 22 wherein the face ply further comprises a third face ply portion, wherein the first, second and third face ply portions are separable from one another.

25. The multi-part form of claim 24 wherein the liner ply comprises first, second and third liner ply portions wherein the first liner ply portion releasably adheres to the first face ply portion, the second liner ply portion releasably adheres to the second face ply portion, and the third liner ply portion adheres to the third face ply portion.

26. The multi-part form of claim 22 wherein first face ply portion is constructed of a polymer and the second face ply portion is constructed of paper.

27. The multi-part form of claim 22 wherein the form comprises a continuous web of forms.

28. The multi-part form of claim 22 wherein the first face ply portion is die cut to form the fastener and the strip, and the second face ply portion is die cut to form the plurality of labels.

29. The multi-part form of claim 28 wherein the face ply further comprises a third face ply portion having a plurality of removable cards formed by a die cut.

30. The multi-part form of claim 22 wherein the fastener has a generally elongated shape with a proximate end and a distal end, the proximate end terminating in a generally triangle-shaped portion having a point and having two wings adapted to be folded toward one another, the distal end having a fastener opening adapted to permit the triangle-shaped portion to pass through the fastener opening when the two wings are folded toward one another and to inhibit the triangle-shaped portion from passing through the fastener opening when the two wings are unfolded.

31. The multi-part form of claim 30 wherein the strip further has a second strip opening, wherein the first strip opening is formed at the first end of the strip and the second strip opening is formed at the second end of the strip, and wherein each of said first and second strip openings is adapted to permit at least a portion of the fastener to pass through.

32. The multi-part form of claim 22 wherein the strip further has a plurality of additional strip openings, wherein the first strip opening and each of said plurality of additional strip openings is adapted to permit at least a portion of the fastener to pass through.

33. The multi-part form of claim 22 further comprising a radio frequency identification (RFID) tag embedded in the face ply.

34. A multi-part form for use with a printer adapted to output a printed image, comprising:
a face ply having a first face ply surface and a second face ply surface wherein one of the first and second face ply surfaces is adapted to receive the printed image, the face ply comprising:
a first face ply portion comprising a strip having a first end and a second end; and
a second face ply portion comprising a plurality of labels;
a liner ply underlying the face ply;
means for releasably adhering the liner ply to the face ply;
wherein each of the plurality of labels is adapted to be separated from the face ply, the liner ply and from each other; and
wherein the strip is adapted to be separated from the face ply and the liner ply; and
means for attaching the first end of the strip to the second end of the strip when the strip is separated from the face ply and the liner ply.

35. The multi-part form of claim 34 further comprising a radio frequency identification (RFID) tag embedded in the face ply.
